(19) United States
(12) Patent Application Publication
(10) Pub. No.: US 2008/0137885 A1
(43) Pub. Date: Jun. 12, 2008

(54) Electret Condenser Microphone

(75) Inventors: Akira Yamamoto, Osaka (JP); Shinichi Saeki, Osaka (JP); Yasuo Sugimori, Osaka (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Hosiden Corporation, Osaka (JP)

(21) Appl. No.: 11/884,858

(22) PCT Filed: Apr. 11, 2006
(86) PCT No.: PCT/JP2006/007668

§ 371 Date: Aug. 21, 2007

(30) Foreign Application Priority Data
Apr. 19, 2005 (JP) 2005-121051

(51) Int. Cl. H04R 25/00

(52) U.S. Cl. 381/174

(57) ABSTRACT

An electret condenser microphone is configured such that a substrate 12 and components stacked on the substrate 12 are fixed in a capsule 2 shaped like a cylinder. The electret condenser microphone includes a top plate 30 having sound holes 31, terminal electrode patterns 11 are provided on the substrate 12, the capsule 2 includes an inner flange portion 21 stretching to the inside of the electret condenser microphone and a curled portion 13 bent inward, the substrate 12 is positioned at the inner flange portion 21, the terminal electrode patterns 11 protrude outside the inner flange portion 21, and the top plate 30 is positioned at the curled portion 13.

### TECHNICAL FIELD

The present invention relates to an electret condenser microphone for preventing a soldering failure and inclination in the mounting of the microphone.

### BACKGROUND ART

FIG. 4 shows an example of a conventional electret condenser microphone. The electret condenser microphone is configured such that components such as a diaphragm ring 3, a diaphragm 4, a spacer 5, rear electrodes 6, a rear electrode holder 7, a gate ring 8, and a substrate 12 are sequentially stacked in a capsule 2 in the direction that comes away from sound holes 1. The capsule 2 is a metallic cylinder having one closed end including the sound holes 1. The end of the capsule 2 is crimped on ground electrode patterns 14 of the substrate 12 on the top of the components to form a curled portion (crimped portion) 13, so that the components are fixed into one unit. The substrate 12 includes conductor patterns 9 and an electronic circuit 10 inside the electret condenser microphone and includes terminal electrode patterns 11 outside the electret condenser microphone. In this case, the electrode patterns 11 and 14 and the conductor patterns 9 are formed by plating or the like on the substrate 12. The thicknesses of the patterns are determined by control in a plating process.

### Patent literature 1: International Publication WO 2005/013641 A1

### Patent literature 2: Japanese Patent Application Laid Open No. 2003-153392

### DISCLOSURE OF THE INVENTION

### Problems to be Solved by the Invention

In the electret condenser microphone of the aforementioned conventional art, the terminal electrode patterns 11 outside the microphone are soldered to the terminals of a mounting substrate (not shown) in a soldering process performed in a reflow chamber. In this case, as described in Patent literatures 1 and 2, in order to perform smooth soldering in the reflow chamber, prevent a soldering failure caused by a short circuit or the like, or reduce the influence of heat on the curled portion, the soldering process in the reflow chamber is performed with the terminal electrode patterns 11 formed on the substrate 12 protruding higher than the top of the curled portion 13 of the capsule 2.

However, the terminal electrode patterns 11 on the substrate 12 vary in thickness even when plating is controlled. Moreover, the components stacked in the capsule 2 vary in thickness and the variations of the thickness are accumulated, and the amount of protrusion of the curled portion 13 varies depending upon the machining accuracy of the curled portion 13. As a result, the amount of protrusion of the terminal electrode patterns 11 is not stabilized relative to the curled portion 13, causing a soldering failure in the reflow chamber or a wrong position (inclination) of the microphone on the mounting substrate in the stage of the mounting of the microphone.

The present invention is designed to solve the above problem and has as its object the provision of an electret condenser microphone for preventing a soldering failure in a reflow chamber or a wrong position of the microphone on a mounting substrate in the stage of the mounting of the microphone.

### Means to Solve the Problems

In order to attain the above object, the present invention is configured as follows: in an electret condenser microphone, a substrate and components stacked on the substrate are fixed inside a capsule shaped like a cylinder thereof, the electret condenser microphone comprising the substrate having terminal electrode patterns, a top plate having sound holes, and the capsule having an inner flange portion stretching inward and a curled portion bent inward, in which the substrate is positioned at the inner flange, the terminal electrode patterns protrude outside the inner flange portion, and the top plate is positioned at the curled portion.

The inner flange portion and the curled portion may be opposed to each other on both ends of the capsule or the top plate may be disposed on the top of the components stacked on the substrate.

Further, the curled portion may be formed by crimping the end of the capsule and the top plate may be in contact with the curled portion.

### EFFECTS OF THE INVENTION

According to the present invention, the substrate is positioned at the inner flange portion of the capsule and the terminal electrode patterns are protruded relative to the inner flange portion having a determined thickness. Thus it is possible to, unlike the conventional art, positively protrude the terminal electrode patterns with ease regardless of the accumulation of variations in thickness of the components and the machining accuracy of the curled portion, thereby preventing a soldering failure in a reflow chamber or a wrong position of a microphone on a mounting substrate in the stage of the mounting of the microphone.

### BRIEF DESCRIPTION OF THE DRAWINGS

FIG. 1 is a sectional view of an electret condenser microphone according to First Embodiment (taken along line F-F of FIG. 2C);

FIG. 2A is a perspective view showing the electret condenser microphone according to First Embodiment from above;

FIG. 2B is a perspective view showing the electret condenser microphone according to First Embodiment from the below;

FIG. 2C is a plan view of the electret condenser microphone according to First Embodiment;

FIG. 3 is a sectional view of an electret condenser microphone according to Second Embodiment; and

FIG. 4 is a sectional view of a conventional example.

### BEST MODES FOR CARRYING OUT THE INVENTION

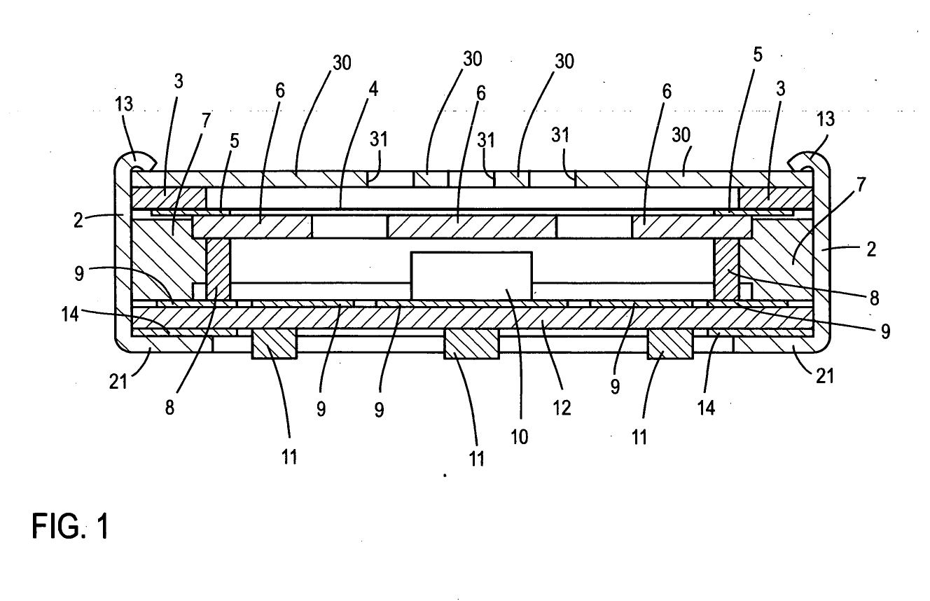

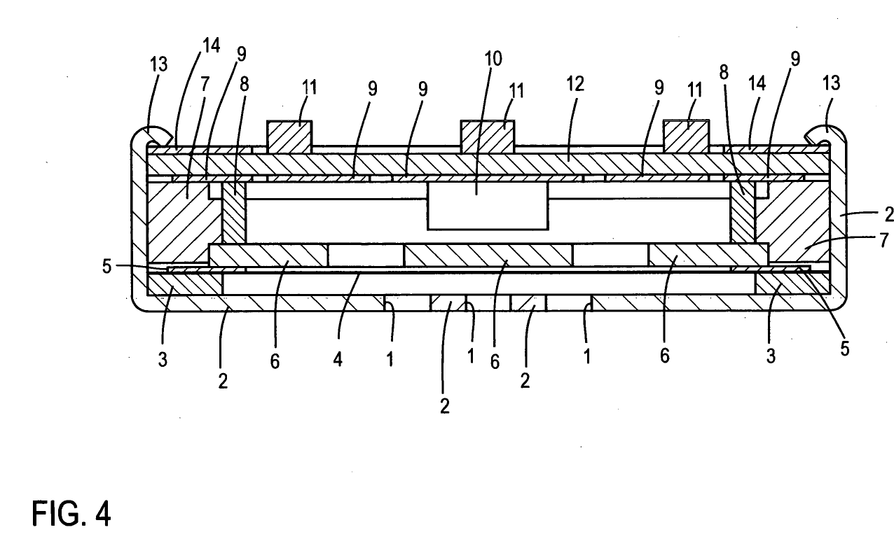

Referring to FIGS. 1 to 3, embodiments of the present invention will now be described below. In FIGS. 1 to 3, the same parts as those of FIG. 4 are indicated by the same reference numerals and the explanation thereof is omitted when not necessary.

### First Embodiment

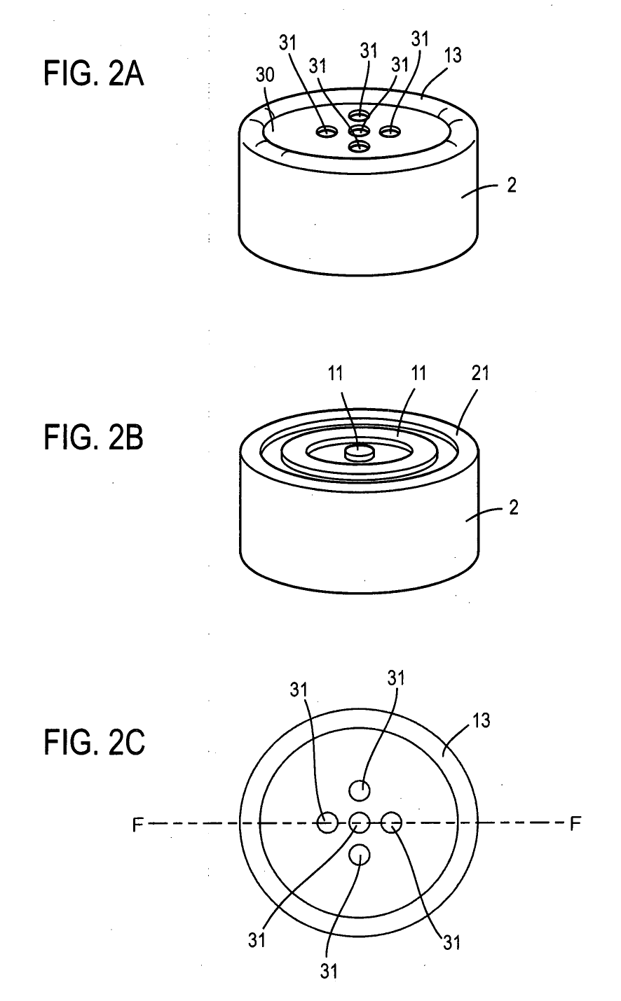

FIG. 1 is a sectional view showing an embodiment of the present invention. FIG. 2 is a perspective view of an electret condenser microphone according to the present embodiment. On the bottom (the underside of a capsule 2 shown in FIG. 1), that is, on one end of the capsule 2 which is a cylinder made of metal (german silver, aluminum, and so on), an inner flange portion 21 stretching to the inside of the electret condenser microphone is formed integrally with the capsule 2 by stamping or the like. A substrate 12 is positioned at the inner flange portion 21. Strictly speaking, a ground electrode pattern 14 formed on the outer edge of the substrate 12 is placed on the inner flange portion 21. Further, terminal electrode patterns 11 are formed on one side of the substrate 12 (in other words, the outside of the electret condenser microphone) by plating, the ground electrode pattern 14 being formed on the same side of the substrate 12. The plated terminal electrode patterns 11 are so thick as to protrude higher than the inner flange portion 21. On the opposite side of the substrate 12 from the side where the ground electrode pattern 14 is formed (in other words, the inside of the electret condenser microphone), conductor patterns 9 are formed and an electronic circuit 10 is placed. To be specific, when a dimension a from a surface of the substrate 12 to a surface (the outer surface) of the inner flange portion 21 is 0.15 mm to 0.20 mm, a plating thickness b of the terminal electrode patterns 11 from the surface of the substrate 12 is about 0.20 mm to 0.25 mm. However, in this case, a<b is satisfied. The larger plating thickness b of the terminal electrode patterns 11, the larger amount of protrusion. In the case of a compact microphone, the amount of protrusion cannot be unlimitedly increased because it is necessary to prevent interference with other members. Thus the amount of protrusion is limited nearly up to the numeric value b described above, depending on the needs of the user of the microphone.

Above the opposite side of the substrate 12 from the side where the ground electrode pattern 14 is formed, a gate ring 8, a rear electrode holder 7, rear electrodes 6, a spacer 5, a diaphragm 4, and a diaphragm ring 3 are sequentially stacked. On the diaphragm ring 3, a top plate 30 including sound holes 31 is placed. The top plate 30 is made of, for example, the same metallic material and has the same thickness as the capsule 2. Further, the top plate 30 is crimped from the above (in other words, from the outside of the electret condenser microphone) by a curled portion 13 which is formed by bending inward the end of the capsule 2 (the opposite end from the inner flange portion 21), so that the substrate 12 and the components are fixed in the capsule 2.

As described above, according to the microphone of the present embodiment, the curled portion 13 is provided on the top plate 30 including the sound holes 31 as shown in FIG. 2. The terminal electrode patterns 11 of the substrate 12 are provided on the side of the inner flange portion 21 of the capsule 2. Unlike the conventional art, the curled portion 13 of the present embodiment does not require highly accurate height control, and it is only necessary to fix the substrate 12 and the components in the capsule 2 and apply crimping force in consideration of the influence of a stress distorting the diaphragm 4. Thus it is possible to ease the conditions of forming the curled portion 13 and facilitate the handling of a crimping tool.

With this configuration, the substrate 12 is directly placed on the inner flange portion 21. Additionally, since the thickness of the inner flange portion 21 is also determined by stamping or the like, unlike the conventional art, even when the terminal electrode patterns 11 formed by plating on the substrate 12 vary in thickness, the amount of protrusion of the terminal electrode patterns 11 relative to the inner flange portion 21 is stabilized regardless of the accumulated error of the stacked components and the height —of the curled portion formed by crimping, thereby positively obtaining a proper amount of protrusion with ease. As a result, it is possible to avoid a soldering failure in a reflow chamber or a wrong position of the microphone on the mounting substrate in the stage of the mounting of the microphone. Further, it is possible to reduce the amount of protrusion of the terminal electrode patterns 11 and also reduce the amount and time of plating of the terminal electrode patterns 11, thereby reducing the manufacturing cost.

### Second Embodiment

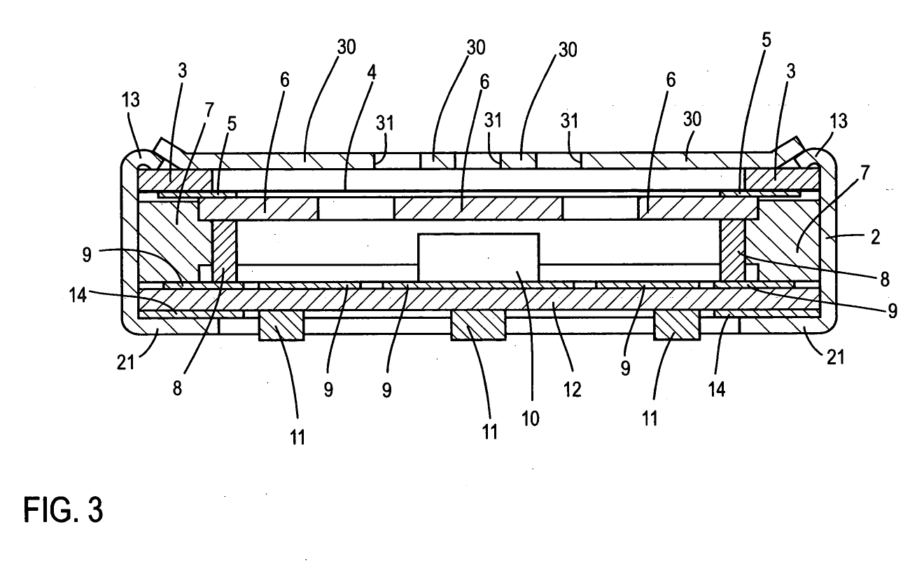

FIG. 3 is a sectional view showing another example of the present embodiment. The example of FIG. 3 is different from that of FIG. 1 in that crimping of a curled portion 13 is performed on a diaphragm ring 3, except for a top plate 30, and the top plate 30 is bonded to the diaphragm ring 3 after the curled portion 13 is formed.

Although the aforementioned examples of FIGS. 1 and 3 illustrate so-called back electret condenser microphones, the present invention is also applicable to so-called front electret condenser microphones.

Although the foregoing embodiments describe that the capsule 2 is made of metal, the material of the capsule is not limited to metal. For example, the capsule 2 may be made of synthetic resin and made conductive by performing plating or the like on the inner wall surface of the capsule 2.

What is claimed is:

1. An electret condenser microphone, in which a substrate and components stacked on said substrate are fixed inside a capsule shaped like a cylinder, comprising:
said substrate having terminal electrode patterns,
a top plate having sound holes, and
said capsule having an inner flange portion stretching inward and a curled portion bent inward,
wherein said substrate is positioned at said inner flange portion, said terminal electrode patterns protrude outside said inner flange portion, and
the top plate is positioned at said curled portion.

2. The electret condenser microphone according to claim 1, wherein said inner flange portion and said curled portion are opposed to each other on both ends of said capsule.

3. The electret condenser microphone according to claim 1 or 2, wherein said top plate is disposed on the top of said components stacked on said substrate.

4. The electret condenser microphone according to claim 1 or 2, wherein
said curled portion is formed by crimping the end of said capsule, and
said top plate is in contact with said curled portion.

5. The electret condenser microphone according to claim 3, wherein
said curled portion is formed by crimping the end of said capsule, and
said top plate is in contact with said curled portion.
